(19) United States
(12) Patent Application Publication
(10) Pub. No.: US 2009/0080742 A1
(43) Pub. Date: Mar. 26, 2009

(54) IMAGE DISPLAY DEVICE AND IMAGE DISPLAY PROGRAM STORAGE MEDIUM

(76) Inventor: Yoshiyuki MORIYA, Tokyo (JP)

Correspondence Address: BIRCH STEWART KOLASCH & BIRCH, PO BOX 747, FALLS CHURCH, VA, 22040-0747, US

(21) Appl. No.: 12/209,320

(22) Filed: Sep. 12, 2008

(30) Foreign Application Priority Data
Sep. 21, 2007 (JP) 2007-245535

(51) Int. Cl. G06K 9/00

(52) U.S. Cl. 382/131

(57) ABSTRACT

An image display device includes: an image acquiring section that acquires sets of cross-sectional images of a subject captured at different image capturing positions arranged in a predetermined direction with respect to the subject; and a target site setting section that sets a target site on a cross-sectional image of one of the cross-sectional image sets acquired by the image acquiring section. The device further includes: a cross-sectional image search section that detects a cross-sectional image including a site corresponding to the target site from a plurality of cross-sectional images forming another one of the cross-sectional image sets excluding the cross-sectional image set having the target site set therein by the target site setting section; and an image display section that displays the cross-sectional image detected by the cross-sectional image search section.

### BACKGROUND OF THE INVENTION

1. Field of the Invention

The present invention relates to an image display device that displays medical images formed by capturing images of a subject, and an image display program storage medium that stores an image display program.

2. Description of the Related Art

In the field of medicine, medical images of the insides of subjects captured with an X-ray device, a ultrasonic device, or an endoscope have been widely used to diagnose medical conditions of the subjects. With the use of medical images for diagnosis changes in the medical condition of each subject can be recognized, without causing external damage to the subject. Also, the information required to determine the treatment course can be readily obtained.

Today, more and more hospitals employ not only X-ray devices and endoscopes, but also CT (Computerized Tomography) devices and MRI (Magnetic Resonance Imaging) devices for capturing cross-sectional images of each subject at different image capturing positions. Those CT devices and MRI devices cause less pain to each subject in medical examinations, compared with an endoscope that inserts an optical probe into the body of each subject. Also, with a CT device or MRI device, the accurate location and size of a lesion can be three-dimensionally recognized with the assistance of cross-sectional images. Accordingly, CT devices and MRI devices are used in comprehensive medical examinations.

Normally, medical images captured for medical examinations are stored together with medical records for each subject. In an actual medical examination, medical images captured at different times are arranged on a monitor for comparative interpretation. Through the comparative interpretation, a change in size of a lesion or the like can be readily recognized. Accordingly, this technique is very useful in determining medical conditions and effects of treatment.

When comparative interpretation is performed with the use of cross-sectional images captured with a CT device or MRI device, for example, cross-sectional images showing the same lesion are selected from the cross-sectional images captured in each of examinations, and the selected cross-sectional images are arranged on a display monitor. However, the process of manually selecting appropriate cross-sectional images from numerous cross-sectional images is very troublesome and time-consuming.

To counter this problem, Japanese Patent Application Publication No. 8-294485 discloses such a technique that uses cross-sectional image sets each including cross-sectional images captured in different medical examinations. In this technique, first, cross-sectional image sets are obtained and then, a cross-sectional images in at least one of the cross-sectional image sets is designated. Subsequently, within the image capturing range of the device that have captured the cross-sectional images, from among the other cross-sectional image sets, the cross-sectional images showing the same position as that shown in the designated cross-sectional images are selected. In accordance with the technique disclosed in Japanese Patent Application Publication No. 8-294485, for instance, if a cross-sectional image showing a lesion or the like is designated among cross-sectional images captured in a first examination, the cross-sectional image captured at the same image capturing position as that of the designated cross-sectional image within the image capturing range is automatically selected from the cross-sectional images captured in a second examination, and the selected image is displayed on a display monitor. Accordingly, the trouble of manually selecting cross-sectional images can be avoided, and the time required for the cross-sectional image selection can be greatly reduced.

However, it is very difficult to capture images of a subject in the exact same position at different times, and therefore, the angles of sections with respect to the subject may slightly vary. Also, the length and width of the body of the subject might vary due to a change in physical frame or the timing of breathing. In such a case, two or more lesions that are seen in one cross-sectional image in a cross-sectional image set might be seen in several cross-sectional images in another cross-sectional image set, or a single lesion might be seen in cross-sectional images showing different cross sections. Therefore, doctors still need to manually reselect appropriate cross-sectional images.

### SUMMARY OF THE INVENTION

The present invention has been made in view of the above circumstances and provides an image display device that can accurately select and display cross-sectional images corresponding to each other from the cross-sectional images forming sets of cross-sectional images, and an image display program storage medium that stores an image display program.

An image display device of the present invention includes:

an image acquiring section that acquires a plurality of sets of cross-sectional images of a subject captured at a plurality of image capturing positions arranged in a predetermined direction with respect to the subject;

a target site setting section that sets a target site on a cross-sectional image of one of the cross-sectional image sets acquired by the image acquiring section;

a cross-sectional image search section that detects a cross-sectional image including a site corresponding to the target site from a plurality of cross-sectional images forming another one of the cross-sectional image sets excluding the cross-sectional image set having the target site set therein by the target site setting section; and

an image display section that displays the cross-sectional image detected by the cross-sectional image search section.

With the image display device of the present invention, a cross-sectional image including a site corresponding to a target site that is set on a cross-sectional image of one cross-sectional image set is detected from the cross-sectional images forming another one of the cross-sectional image sets, instead of the cross-sectional image set having the target site designated therein. The detected cross-sectional image is displayed on the display screen. Accordingly, even if a lesion location or the like is seen in cross-sectional images of different image capturing positions between the cross-sectional image sets due to changes in posture or the like of the subject, a target site is designated on a cross-sectional image of one of the cross-sectional image sets, so that the cross-sectional image showing a site corresponding to the target site is automatically detected from another one of the cross-sectional image sets. Thus, changes in medical condition and the like can be readily compared side-by-side.

In the image display device according to the present invention, preferably, the image display section displays the cross-sectional image having the target site set thereon by the target site setting section and the cross-sectional image detected through the search performed by the cross-sectional search section side by side.

Where the cross-sectional image having the target site set thereon and the cross-sectional image detected through the search carried out by the cross-sectional image search section are displayed side by side, the differences at the target site between the cross-sectional images can be accurately recognized.

In the image display device according to the present invention, preferably, the target site setting section is capable of setting a plurality of target sites on a cross-sectional image; and

the cross-sectional image search section searches each cross-sectional image for sites corresponding to the target sites set by the target site setting section.

With this preferred image display device, each cross-sectional image is searched for each of two or more target sites by setting the target sites on one cross-sectional image. Thus, changes at several lesion sites can be recognized at once.

The image display device according to the present invention preferably further includes a displacement correcting section that corrects displacements between cross-sectional images of the cross-sectional image sets,

wherein the cross-sectional image search section detects a cross-sectional image including the target site from the cross-sectional images having the displacements corrected by the displacement correcting section.

Image matching techniques for correcting displacements between images have been widely known. A cross-sectional image including a target site can be more accurately detected by correcting displacements between cross-sectional images with the use of one of the image matching techniques.

In the image display device according to the present invention, preferably, the plurality of cross-sectional image sets are obtained by photographing the same subject at different times.

With this image display device, a change in size of a lesion or the like in the subject can be readily recognized.

In the image display device according to the present invention preferably, the cross-sectional image search section searches for a cross-sectional image including a site corresponding to the target site, with the assistance of image features that are obtained beforehand by a machine learning technique.

In recent years, “machine learning” is widely used to cause computers to learn the relations between various scenes and the features of the images of those scenes. In the machine learning process, sample images of the various scenes are captured, and the quantities of image features of numerous types such as the maximum value, the minimum value, the mean value, and the intermediate value of pixel values are calculated with respect to the respective sample images. With the use of the machine learning technique, large quantities of features that cannot be handled by humans can be used, and correlations that cannot be predicted by the human brain can be found. Accordingly, the machine learning technique is known to realize high-precision determinations. With the use of such a machine learning technique, a cross-sectional image including a site corresponding to the target site can be readily and accurately extracted.

Also, an image display program storage medium of the present invention stores an image display program that is executed in a computer to implement in the computer:

an image acquiring section that acquires a plurality of sets of cross-sectional images of a subject captured at a plurality of image capturing positions arranged in a predetermined direction with respect to the subject;

a target site setting section that sets a target site on a cross-sectional image of one of the cross-sectional image sets acquired by the image acquiring section;

a cross-sectional image search section that detects a cross-sectional image including a site corresponding to the target site from a plurality of cross-sectional images forming another one of the cross-sectional image sets excluding the cross-sectional image set having the target site set therein by the target site setting section; and

an image display section that displays the cross-sectional image detected by the cross-sectional image search section.

In accordance with the image display program storage medium of the present invention, it is possible to form an image display device that accurately selects and displays cross-sectional images corresponding to each other from the cross-sectional images forming each of sets of cross-sectional images.

Although only the basic feature of the image display program storage medium is described here to avoid repetitive explanation, the image display program storage medium of the present invention may have variations equivalent to the above variations of the image display device, as well as the above basic feature.

Further, each element such as the image acquiring section formed in the computer by the image display program of the present invention may be formed with one program component. Alternatively, more than one element may be formed with one program component. Those elements may be designed to carry out the respective procedures, or may be designed to issue instructions to other programs or program components installed in the computer so as to carry out the procedures.

In accordance with the present invention, cross-sectional images corresponding to each other can be accurately selected from cross-sectional images forming sets of cross-sectional images, and are then displayed.

### BRIEF DESCRIPTION OF THE DRAWINGS

FIG. 1 schematically shows the structure of a medical diagnosis system to which an embodiment of the present invention is implemented;

FIG. 2 shows the hardware structure of the diagnosis device;

FIG. 3 is a conceptual diagram of a CD-ROM;

FIG. 4 is a functional block diagram of the medical image display device;

FIG. 5 is a flowchart showing a series of procedures that start from acquiring medical images from the management server and end with displaying the acquired medical images;

FIG. 6 shows medical images that are sent from the management server;

FIG. 7 shows an example of a cross-sectional image display screen;

FIG. 8 is a flowchart showing an operation to be performed to correct displacements;

FIG. 9 illustrates a cross-sectional image search;

FIG. 10 shows an example of a cross-sectional image display screen on which detected cross-sectional images are displayed;

FIG. 11 shows an example of a cross-sectional image display screen;

FIG. 12 is a flowchart showing a cross-sectional image search in accordance with a second embodiment of the present invention;

FIG. 13 is a flowchart showing an operation to be performed to adjust the positions of predicted regions V1 and V2 to each other; and

FIG. 14 shows a cross-sectional image display screen on which detected cross-sectional images are displayed.

### DETAILED DESCRIPTION OF THE INVENTION

The following is a description of embodiments of the present invention, with reference to the accompanying drawings.

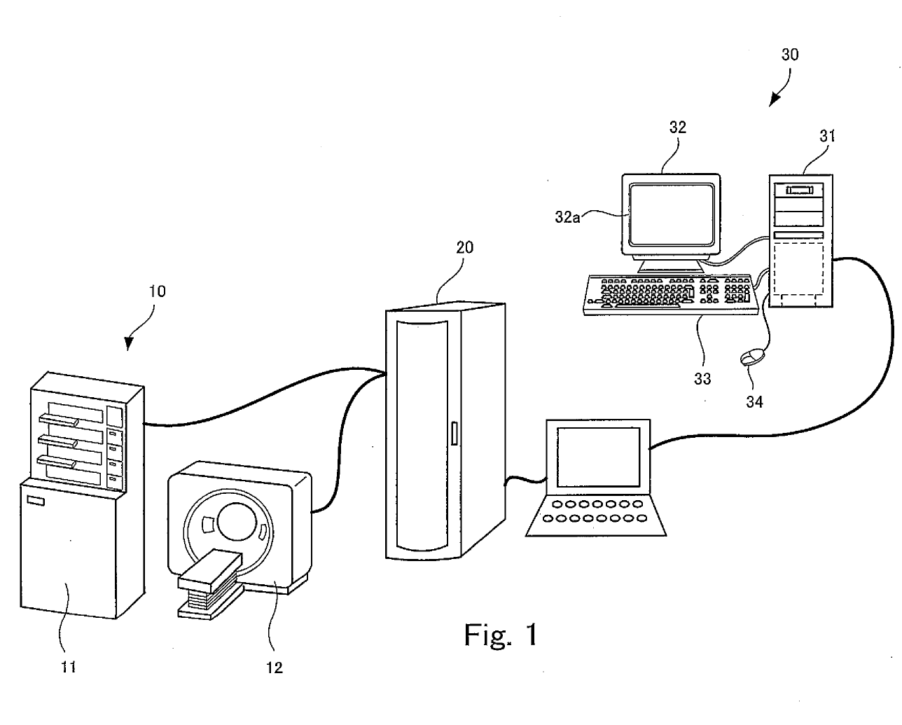

FIG. 1 schematically shows the structure of a medical diagnosis system in accordance with an embodiment of the present invention.

The medical diagnosis system shown in FIG. 1 includes an image generating device 10 that generates medical images by capturing images of the inside of the body of a subject, a management server 20 that stores medical images and medical records, and a diagnosis device 30 that displays medical images. The image generating device 10 is connected to the management server 20 via a network line, and the management server 20 is connected to the diagnosis device 30 via a network line.

In this medical diagnosis system, an identification number for identifying a subject is allotted to each new subject. The identification number is associated with a medical record showing the name, age, medical history and the like of the subject, and is registered in the management server 20.

The image generating device 10 includes a CR device 11 that generates digital medical images by emitting radiation to a subject and reading radiation passing through the subject, a MRI device 12 that generates tomographic images of a subject with the use of an intense magnetic field and radio wave, a CT device (not shown) that generates tomographic images of a subject with the use of radiation, a ultrasonic device (not shown) that generates medical images by reading a ultrasonic echo and the like. Each medical image generated by the image generating device 10 and the identification number for identifying the subject of the medical image are sent together to the management server 20.

When a medical image accompanied by an identification number is transmitted from the image generating device 10, the management server 20 stores the medical image associated with the identification number. That is, in the management server 20,identification numbers, the medical records of subjects having identification numbers allotted thereto are associated with medical images of the subjects.

In appearance, the diagnosis device 30 includes a main unit 31, an image display device 32 that displays images on a display screen 32a in accordance with an instruction from the main unit 31, a keyboard 33 that inputs various kinds of information to the main unit 31 in accordance with key operations, and a mouse 34 that designates any position on the display screen 32a and inputs an instruction in accordance with, for example, an icon or the like displayed in the position.

When a user inputs the name or identification number of a subject with the use of the mouse 34 of the diagnosis device 30 and the like, the management server 20 is notified of the contents of the input. The management server 20 sends the diagnosis device 30 the medical images and medical record associated with the name or identification number of the subject transmitted from the diagnosis device 30. In the diagnosis device 30, the medical images sent from the management server 20 are displayed on the display screen 32a. Seeing the medical images displayed on the display screen 32a of the diagnosis device 30, the user can diagnose the condition of the subject, without causing external damage to the subject.

Seeing the medical images displayed on the display screen 32a of the diagnosis device 30, the user diagnoses the condition of the subject, and edits the medical record with the use of the mouse 34 or the keyboard 33. The edited medical record is sent to the management server 20, and the medical record stored in the management server 20 is replaced with the new medical record sent from the diagnosis device 30.

The medical diagnosis system shown in FIG. 1 is basically configured as described above.

This medical diagnosis system as an embodiment of the present invention is characterized by operation procedures to be carried out by the diagnosis device 30. In the following, the diagnosis device 30 will be described in detail.

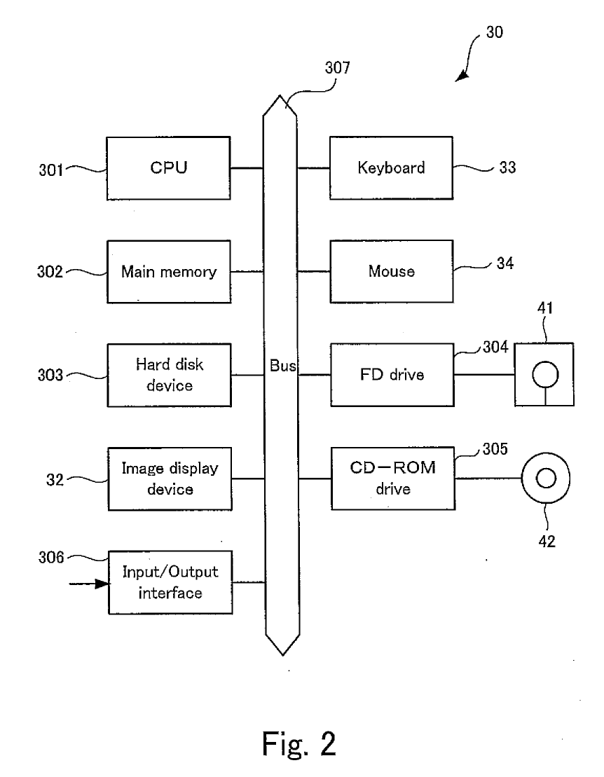

FIG. 2 illustrates the hardware structure of the diagnosis device 30.

As shown in FIG. 2, the main unit 31 of the diagnosis device 30 includes: a CPU 301 that executes various programs; a main memory 302 into which programs read from a hard disk device 303 are loaded for execution by the CPU 301; the hard disk device 303 that stores the various programs, data and the like; a FD drive 304 that has a FD 41 mounted thereon and accesses the FD 41; a CD-ROM drive 305 that accesses a CD-ROM 42; and an input/output interface 306 that receives image data and the like from the management server 20, and transmits various instruction data to the management server 20. Those components of the diagnosis device 30, the image display device 32, the keyboard 33, and the mouse 34 also shown in FIG. 1 are connected to one another via a bus 307.

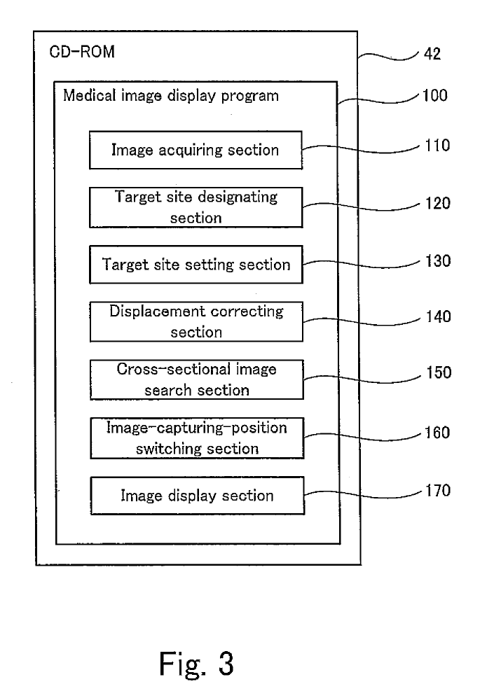

Here, a medical image display program 100 (see FIG. 3) is stored in the CD-ROM 42 which is an embodiment of the image display program storage medium of the present invention, so as to implement an embodiment of the image display device of the present invention in the diagnosis device 30.

FIG. 3 is a conceptual diagram of the CD-ROM 42.

As shown in FIG. 3, the medical image display program 100 stored in the CD-ROM 42 includes an image acquiring section 110, a target site designating section 120, a target site setting section 130, a displacement correcting section 140, a cross-sectional image search section 150, an image-capturing-position switching section 160, and an image display section 170.

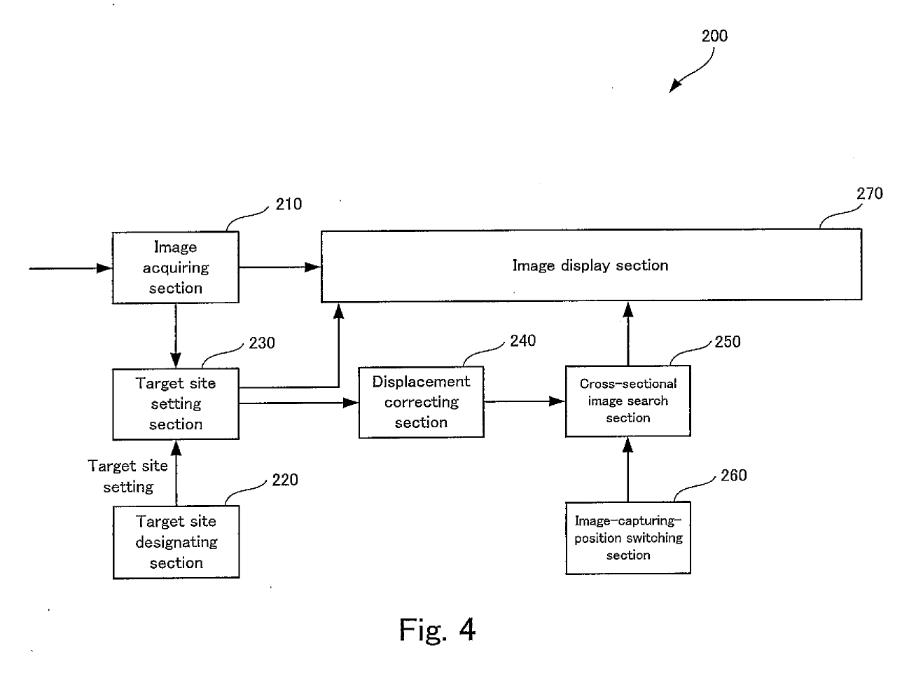

The CD-ROM 42 is mounted on the CD-ROM drive 305 of the diagnosis device 30. The medical image display program 100 stored in the CD-ROM 42 is uploaded into the diagnosis device 30, and is then stored in the hard disk device 303. The medical image display program 100 is activated and executed, so as to implement a medical image display device 200 (see FIG. 4), which serves as an embodiment of the image display device of the present invention, in the diagnosis device 30.

In the above description, the CD-ROM 42 is described as the recording medium that stores the medical image display program 100. However, the recording medium for storing the medical image display program 100 is not necessarily a CD-ROM, and may be some other recording medium such as an optical disk, a MO, a FD, or magnetic tape. Alternatively, the medical image display program 100 may be supplied directly to the diagnosis device 30 via the input/output interface 306.

The respective sections of the medical image display program 100 will be described below in conjunction with the operations of the respective sections of the medical image display device 200.

FIG. 4 is a functional block diagram of the medical image display device 200.

The medical image display device 200 includes an image acquiring section 210, a target site designating section 220, a target site setting section 230, a displacement correcting section 240, a cross-sectional image search section 250, an image-capturing-position switching section 260, and an image display section 270.

The image acquiring section 210, the target site designating section 220, the target site setting section 230, the displacement correcting section 240, the cross-sectional image search section 250, the image-capturing-position switching section 260, and the image display section 270 of the medical image display device 200 have one-to-one correspondence with the image acquiring section 110, the target site designating section 120, the target site setting section 130, the displacement correcting section 140, the cross-sectional image search section 150, the image-capturing-position switching section 160, and the image display section 170 of the medical image display program 100 shown in FIG. 3.

The respective sections shown in FIG. 4 are each formed with a combination of computer hardware and an OS or application program to be executed by the computer, while the respective sections of the medical image display program shown in FIG. 3 are each formed only with an application program.

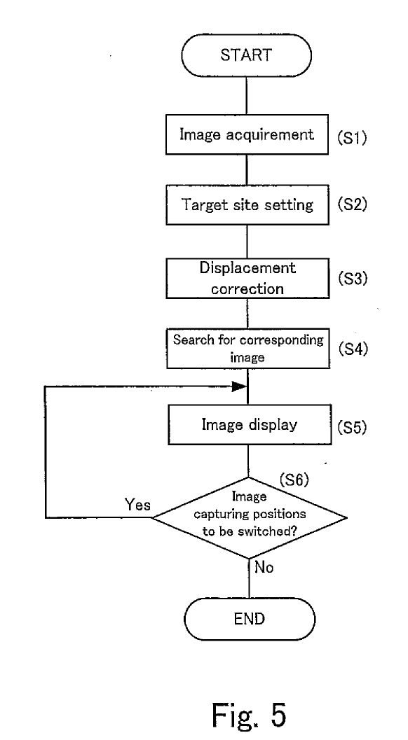

FIG. 5 is a flowchart showing a series of procedures to be carried out in the medical image display device 200 shown in FIG. 4, starting from acquisition of medical images from the management server 20, and ending with displaying the acquired medical images.

Referring now to the flowchart of FIG. 5, the operations of the respective sections of the medical image display device 200 shown in FIG. 4 are described in conjunction with the respective sections of the medical image display program 100 shown in FIG. 3.

When a user uses the mouse 34 and the keyboard 33 shown in FIG. 1 to input the name or identification number of a subject to be diagnosed, the contents of the input are transmitted to the management server 20 via the input/output interface 306 shown in FIG. 2. The management server 20 sends the diagnosis device 30 the medical images and medical record associated with the name or identification number transmitted from the diagnosis device 30.

The medical images sent from the management server 20 are acquired by the image acquiring section 210 shown in FIG. 4 (step S1 of FIG. 5). The image acquiring section 210 is equivalent to an example of the image acquiring section according to the present invention.

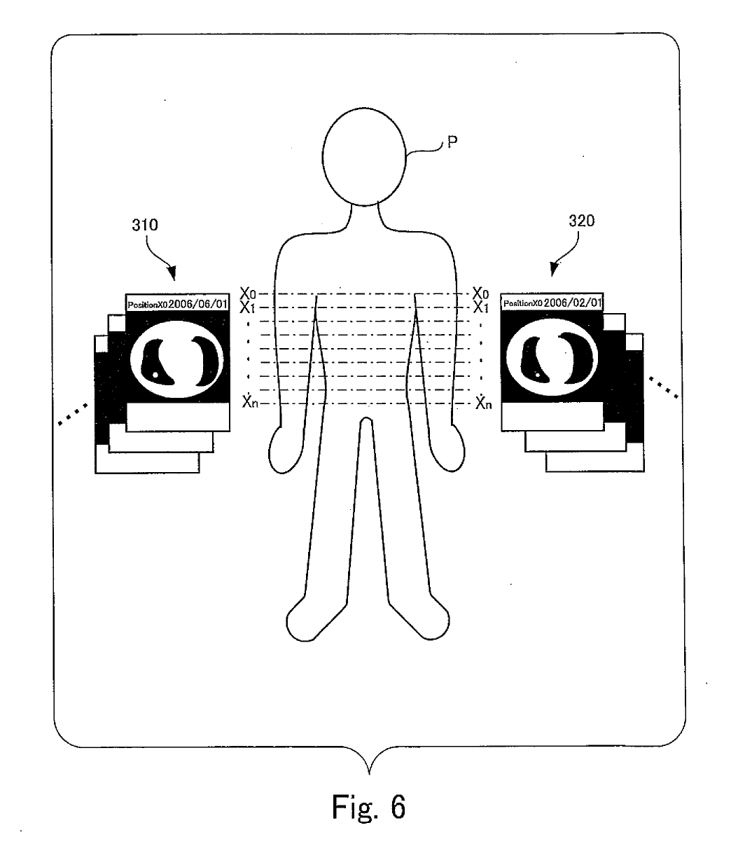

FIG. 6 shows a medical image that is sent from the management server 20.

The MRI device 12 shown in FIG. 1 captures cross-sectional images of a subject P taken at predetermined intervals within an image capturing range from the chest to the tips of the tows of the subject P, who is laid on an examination table, with his/her head being placed at a predetermined position. To the captured cross-sectional images, coordinates X0 through Xn of the image capturing positions of the cross-sectional images within the image capturing range are allotted. In this embodiment, images of the subject P are captured with the MRI device 12 at two different times, and cross-sectional image sets 310 and 320 each including cross-sectional images are generated in the respective image capturing operations. The cross-sectional image sets 310 and 320 are stored in the management server 20. The image acquiring section 210 acquires the cross-sectional image sets 310 and 320 of the two different times, and the acquired cross-sectional image sets 310 and 320 are transmitted to the image display section 270 and the target site setting section 230.

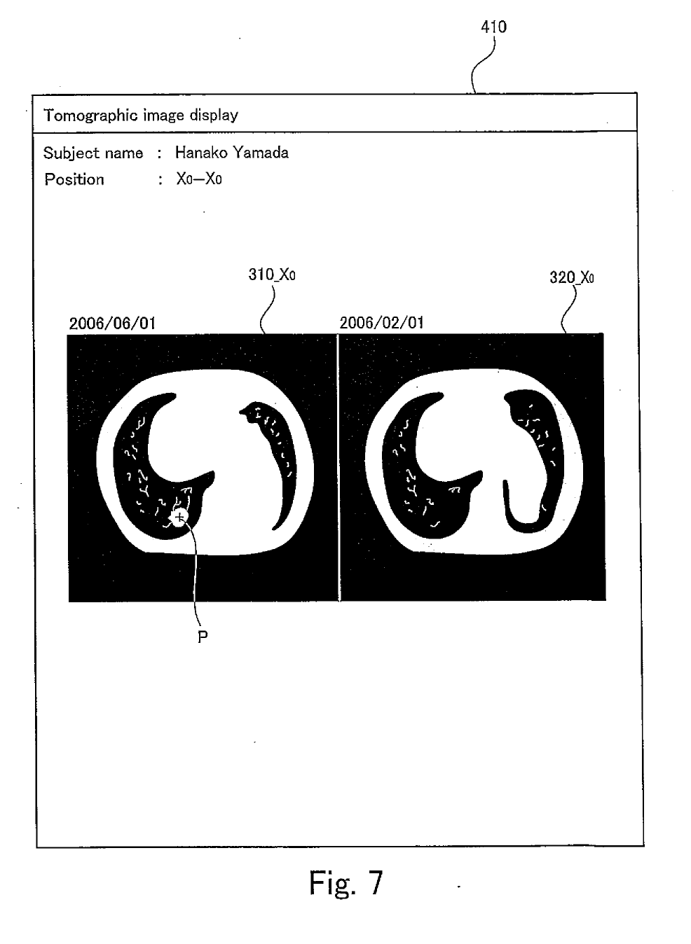

In the image display section 270, a cross-sectional image display screen 410 (see FIG. 7) including the cross-sectional image sets 310 and 320 transmitted from the image acquiring section 210 is displayed on the display screen 32a shown in FIG. 1. The image display section 270 is equivalent to an example of the image display section according to the present invention.

FIG. 7 shows an example of the cross-sectional image display screen.

The cross-sectional image display screen 410 shown in FIG. 7 displays cross-sectional images 310_X0 and 320_X0 captured at an image capturing position X0, as well as the image capturing position at which the cross-sectional images 310_X0 and 320_X0 are captured, the image capturing dates, and the name of the subject.

The two cross-sectional images 310_X0 and 320_X0 are images of the section of the same subject at the same image capturing position captured at different times. However, the body axis direction of the subject at the same image capturing position slightly shifts due to changes in posture and physical frame of the subject, the timing of breathing and the like. In the example shown in FIG. 7, a lesion location P suspected to be a focal site is seen in the left cross-sectional image 310_X0 captured first, but is not seen in the right cross-sectional image 320_X0 captured second.

In the medical image display device 200 of this embodiment, target site P1 is first set on one of the two cross-sectional images 310_X0 and 320_X0 (step S2 of FIG. 5). In the example shown in FIG. 7, when the user clicks a target point (the lesion location P) on the left cross-sectional image 310_X0 with the mouse 34 shown in FIG. 1, the information as to the position of the clicked target site is transmitted from the target site designating section 220 to the target site setting section 230 shown in FIG. 4.

Of the cross-sectional images 310_X0 and 320_X0, the target site setting section 230 determines the designated target point to be the target site PI on the cross-sectional image having the designated target point. In the example shown in FIG. 7, the lesion location P on the left cross-sectional image 310_X0 is clicked, so as to determine the lesion location P to be the target site P1. The information as to the location of the determined target site P1 and the cross-sectional image sets 310 and 320 is transmitted to the displacement correcting section 240. The target site setting section 230 is equivalent to an example of the target site setting section according to the present invention.

The displacement correcting section 240 corrects three-dimensional relative displacements between the cross-sectional image sets 310 and 320 (step S3 of FIG. 5). The displacement correcting section 240 is equivalent to an example of the displacement correcting section according to the present invention.

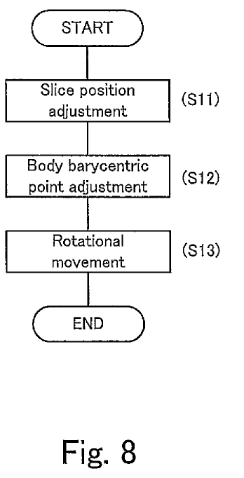

FIG. 8 is a flowchart showing an operation to be performed to correct displacements.

The displacement correcting section 240 first corrects the differences in mechanical image-capturing position between the cross-sectional images of the cross-sectional image set 310 and 320 (step S11 of FIG. 8). In this embodiment, the cross-sectional images of the same image capturing position in the image capturing range are linked to each other, and the mechanical differences in position between the cross-sectional images are corrected by each linking. The mechanical displacement correcting technique is disclosed in Japanese Patent Application Publication No. 8-294485 or the like, and therefore, the technique is not described in detail in this specification. At this point, two cross-sectional images at the same position in the image capturing range are linked to each other, but it is not clear which part (body-axis position) of the subject is seen in the two cross-sectional images.

When two cross-sectional images are linked to each other, the site of the same coordinates as the target site P1 on the cross-sectional image having the target point designated is determined to be possible target site P2 on the cross-sectional image not having the target site P1 of the linked cross-sectional images. In the example shown in FIG. 7, the coordinates of the target site P1 on each cross-sectional image of the cross-sectional image set 310 having the lesion location P designated thereon are expressed as P1 (x, y, z)=(p1x, p1y, p1z), and the coordinates of the possible target site P2 on the corresponding cross-sectional image of the cross-sectional image set 320 are expressed as P2 (x, y, z) (p1x, p1y, p2z). The Z-coordinate value of the possible target site P2 “p2” is the corresponding coordinate value of the image capturing position of each cross-sectional image.

The body area showing the subject is extracted from each cross-sectional image of the cross-sectional image sets 310 and 320 respectively, and the barycentric positions of the respective body areas are adjusted to each other (step S12 of FIG. 8). In the example shown in FIG. 7, the area having a higher density value than a predetermined threshold value is extracted as the body area from each cross-sectional image of the cross-sectional image sets 310 and 320. The coordinates of the barycentric position of the body area in each cross-sectional image of the cross-sectional image set 310 having the lesion location P designated thereon are calculated, and each cross-sectional image of the other cross-sectional image set 320 is moved in parallel, so that the barycentric position of the body area meets the calculated barycentric position.

Further, the torsional directions of the cross-sectional image sets 310 and 320 are adjusted to each other (step S13 of FIG. 8). In the example shown in FIG. 7, the major axis of the body area in each cross-sectional image of the cross-sectional image set 310 having the lesion location P designated thereon is calculated. Each cross-sectional image of the other cross-sectional image set 320 is then rotationally moved, so that the major axis of the body area of each cross-sectional image is adjusted to the calculated body axis.

In this manner, differences in position between the cross-sectional image sets 310 and 320 are corrected. The information as to the cross-sectional image sets 310 and 320 having the displacements corrected is then transmitted to the cross-sectional image search section 250.

Based on the information as to the cross-sectional image sets 310 and 320 transmitted from the displacement correcting section 240, the cross-sectional image search section 250 searches the cross-sectional images of the cross-sectional image set not having the designated target point, for a cross-sectional image having a target site P1′ corresponding to the target site P1 (step S4 of FIG. 5). The cross-sectional image search section 250 is equivalent to an example of the cross-sectional image search section according to the present invention.

The following is a detailed description of the cross-sectional image search operation.

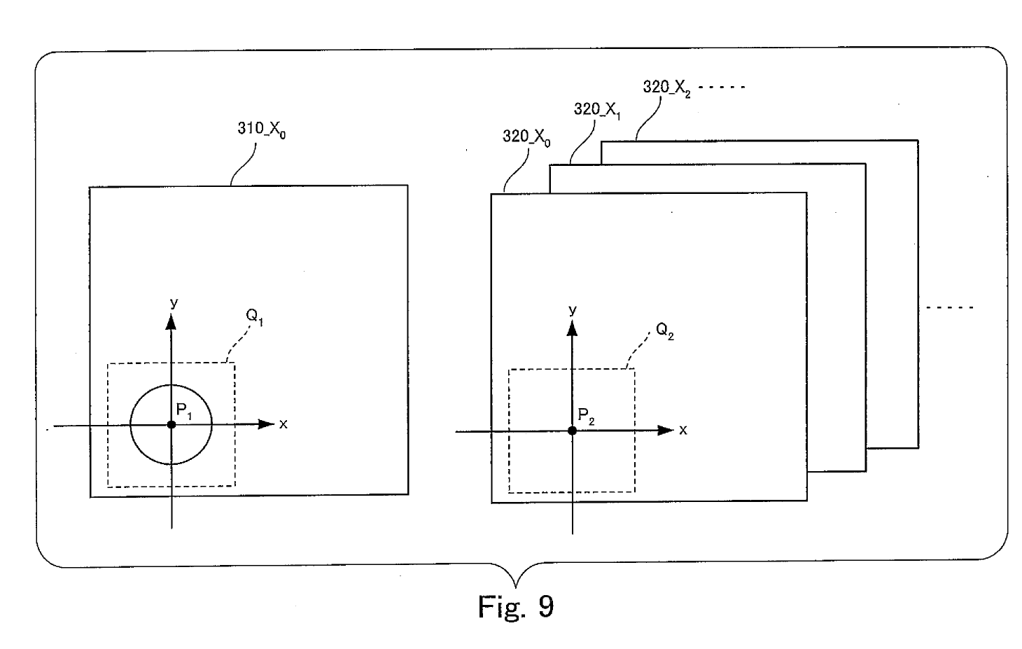

FIG. 9 illustrates the cross-sectional image search operation.

In the displacement correcting operation shown in FIG. 8, the positions of two cross-sectional images of the same image capturing position of the cross-sectional image sets 310 and 320 are adjusted to each other in the x- and y-directions shown in FIG. 9. In this operation, a search is carried out, with attention being drawn to the “slice direction” (the z-direction) along the image capturing positions.

First, in the left cross-sectional image 310_X0 having the target point designated thereon, the pixel value N1 (x, y) at each point (x, y) within a vicinity area Q1 of the target site P1 is obtained.

The possible target site P2 that is located on the right cross-sectional image 320_X0 not having the target point designated thereon and have the same coordinates as the target site P1 is moved in the slice direction (the z-direction) within a predetermined range (within 20 pixels), and the pixel value N2 (x, y) of each point (x, y) within a vicinity area Q2 of the possible target site P2(z) is obtained. In this manner, the pixel values N2 in the cross-sectional images before and after the cross-sectional image 320_X0 of the cross-sectional image set 320 are obtained.

Further, the degree of the image matching between each possible site P2(z) and the target site P1 is evaluated. The square of the difference between the pixel value N1 (x, y) based on the target site P1 and the pixel value N2 (x, y) based on each possible target site P2(z) is calculated, and the total sum of the squares is determined to be an evaluation value (z). As a result, the evaluation values (z) as to the cross-sectional image 320_X0 and the cross-sectional images 320_{—}z including the cross-sectional image 320_X0 and images before and after the cross-sectional image 320_X0 are calculated.

A smaller evaluation value (z) indicates that the degree of image matching between the cross-sectional image 310_X0 and the cross-sectional images 320_{—}z is higher. Among the cross-sectional images 320_{—}z subjected to the calculation, the cross-sectional image 320_Xn having the smallest evaluation value (z) is determined to be the search object, and the possible site P2 on this cross-sectional image 320_Xn is determined to be the target site P1′ corresponding to the target site P1 on the cross-sectional image 310_X0.

In this embodiment, the degree of image matching is evaluated on the basis of the total sum of the squares of the differences between the pixel value N1 (x, y) based on the target site P1 and the pixel values N2 (x, y) based on the possible target sites P2(z). However, the cross-sectional image search section of the present invention may evaluate the degree of image matching on the basis of the correlation coefficient between the pixel value N1 (x, y) and each pixel value N2 (x, y), or may evaluate the degree of image matching on the basis of the amount of mutual information between the pixel value N1 (x, y) and each pixel value N2 (x, y), for example. Alternatively, the image matching technique disclosed in Japanese Patent Application Publication No. 2001-169182 and the like may be utilized.

The cross-sectional image 320_Xn detected by the cross-sectional image search section 250 is transmitted to the image display section 270.

The image display section 270 displays the cross-sectional image 320_Xn transmitted from the cross-sectional image search section 250, after replacing the cross-sectional image 320_X0 that does not have the target point designated thereon and is displayed on the cross-sectional image display screen 410 shown in FIG. 7 (step S5 of FIG. 5).

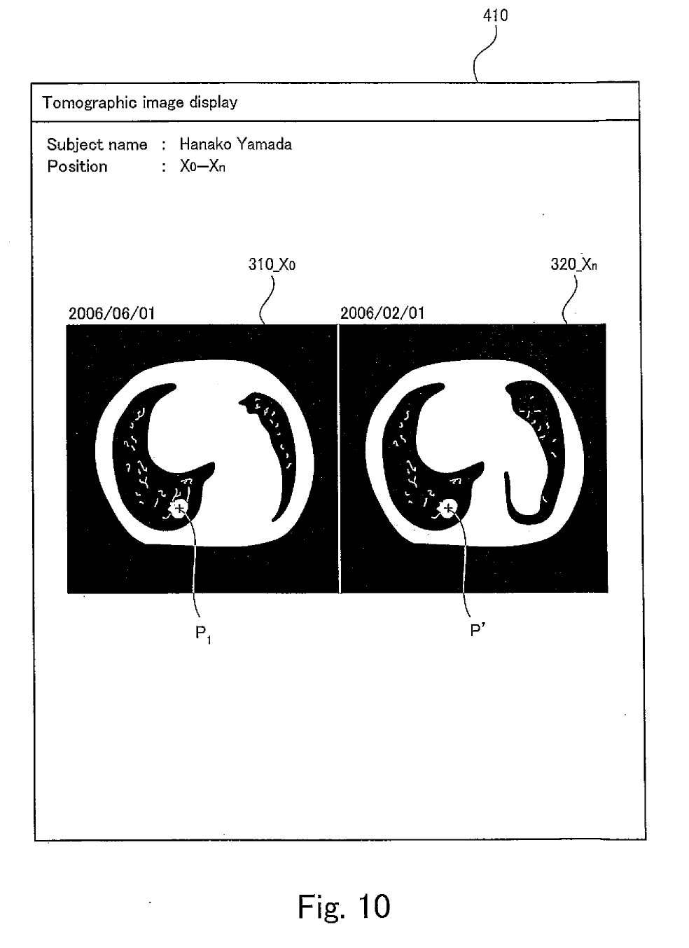

FIG. 10 shows an example of the cross-sectional image display screen 410 on which the detected cross-sectional image 320_Xn is displayed.

On the cross-sectional image display screen 410 shown in FIG. 10, the cross-sectional image 320_Xn including the target site P1′ corresponding to the target site P1 on the cross-sectional image 310_X0 is displayed next to the cross-sectional image 310_X0 having the target point designated thereon. The respective target sites P1 and P1′ are marked with symbols.

As described above, even if a lesion location or the like is seen in cross-sectional images of different image capturing positions between the cross-sectional image sets due to changes in posture or the like of the subject, the cross-sectional image showing the lesion location is automatically searched for and is then displayed in this embodiment. Thus, changes in medical condition and the like can be readily compared side-by-side.

When the user turns the wheel of the mouse 34 while the images shown in FIG. 10 are displayed, an instruction to switch image capturing positions is sent from the image-capturing-position switching section 260 shown in FIG. 4 to the cross-sectional image search section 250 (Yes in step S6 of FIG. 5).

The cross-sectional image search section 250 transmits cross-sectional images 310_Xm and 320_Xn+m of image capturing positions Xm and Xn+m to the image display section 270. The image capturing positions Xm and Xn+m are away, in the direction corresponding to the wheel turning direction, from the image capturing positions X0 and Xn of the currently displayed cross-sectional images 310_X0 and 320_Xn, by the distance equivalent to the amount of the wheel turning. The image display section 270 displays the cross-sectional images 310_Xm and 320_Xn+m on the cross-sectional image display screen 410 (step S4 of FIG. 5).

By switching image capturing positions in accordance with an instruction from a user in this manner, a lesion location can be observed at various image capturing positions, and the shape and size of the lesion can be three-dimensionally recognized.

As described above, with the medical image display device 200 of this embodiment, users can accurately recognize changes in a lesion or the like displayed in each of medical images.

The first embodiment of the present invention has been described so far, and a second embodiment of the present invention will be described. The second embodiment of the present invention has substantially the same structure as that of the first embodiment shown in FIG. 4. The same components as those shown in FIG. 4 are denoted by the same reference numerals as those used in FIG. 4, and explanation of them is omitted here. Only the different aspects from the first embodiment are described below.

In the medical image display device 200 of this embodiment, the target site designating section 220 can designate more than one target site on one cross-sectional image.

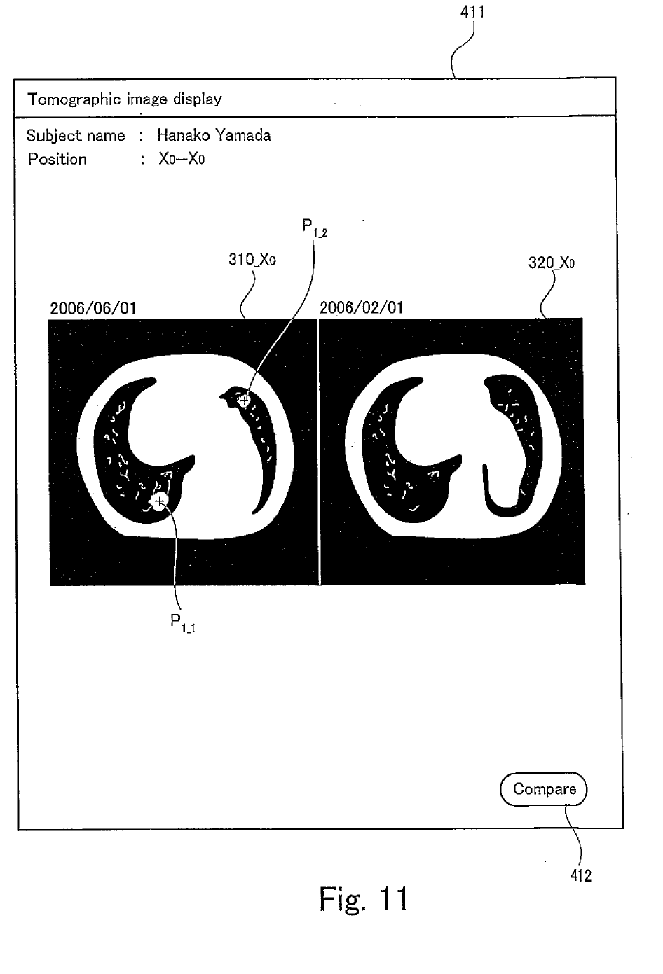

FIG. 11 illustrates an example of a cross-sectional image display screen.

Like the cross-sectional image display screen 410 shown in FIG. 7, the cross-sectional image display screen 411 shown in FIG. 11 displays the cross-sectional images 310_X0 and 320_X0 of one image capturing position X0 among the cross-sectional images forming the cross-sectional image sets 310 and 320 shown in FIG. 6.

When a user designates two target points on the left cross-sectional image 310_X0 and selects a comparison button 412, for example, the target site setting section 230 shown in FIG. 4 determines the designated two target points to be target sites P1_1 and P1_2.

In this embodiment, the displacement correcting section 240 shown in FIG. 4 is not provided, and the information as to the positions of the target sites P1_1 and P1_2 set by the target site setting section 230 is transmitted directly to the cross-sectional image search section 250.

The cross-sectional image search section 250 searches the cross-sectional images forming the cross-sectional image set 320 for the cross-sectional image showing the sites corresponding to the two target sites P1_1 and P1_2. For ease of explanation, the target sites P1_1 and P1_2 will be hereinafter referred to as the target sites P1.

In recent years, “machine learning” is widely used to cause computers to learn the relations between various scenes and the features of the images of those scenes. In the machine learning process, sample images of the various scenes are captured, and the quantities of image features of numerous types such as the maximum value, the minimum value, the mean value, and the intermediate value of pixel values are calculated with respect to the respective sample images. With the use of the machine learning technique, large quantities of feature that cannot be handled by humans can be used, and correlations that cannot be predicted by the human brain can be found. Accordingly, the machine learning technique is known to realize high-precision determinations. The image features of the lesion sites in the cross-sectional images are stored beforehand in the cross-sectional image search section 250 of this embodiment, and the cross-sectional image search section 250 searches the cross-sectional images with the use of the machine learning technique.

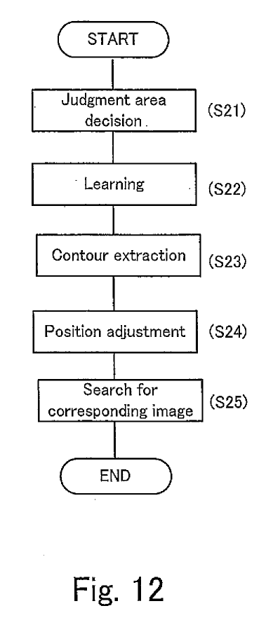

FIG. 12 is a flowchart showing a cross-sectional image search operation in accordance with this embodiment.

The cross-sectional image search section 250 first detects the possible target site 22 of the same position as the target site P1 designated on the cross-sectional image 310_X0, from the cross-sectional image 320_X0. The cross-sectional image search section 250 further determines target areas R1 and R2 surrounding the target sites P1 and P2 on the respective cross-sectional images 310_X0 and 320_X0 (step S21 of FIG. 12). The target areas R1 and R2 are each designed to have such a size as to be able to cover a common tumor or the like, based on empirical values.

The image feature of each of the pixels forming the target areas R1 and R2 is analyzed, and the pixels having the same image feature as the image feature of the lesion site stored beforehand are detected from the pixels forming the target areas R1 and R2 (step S22 of FIG. 12).

A check is made to determine whether each of the pixels having the same image feature as the lesion site has the same contour as the lesion site, and the contours of predicted regions V1 and V2 predicted to be lesion sites including the target sites P1 or the possible target site P2 are extracted from the target areas R1 and R2 (step S23 of FIG. 12).

When a target site designation is received, the contours of the predicted regions V1 and V2 including the target site are extracted through steps S21, S22, and S23 of FIG. 12, and the major axis and the minor axis of the lesion area are measured. The series of those procedures can be carried out through a technique devised as “one-click measurement”.

In this embodiment, after the differences in position between the predicted regions V1 and V2 are corrected (step S24 of FIG. 12), a cross-sectional image search is carried out (step S25 of FIG. 12).

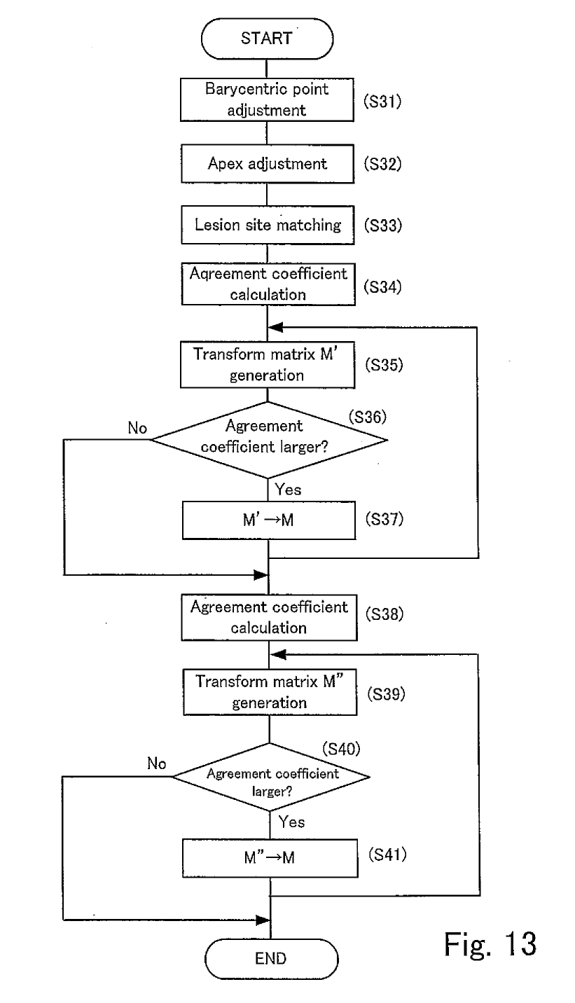

FIG. 13 is a flowchart showing the procedures for positioning the predicted regions V1 and V2.

First, inscribed rectangular parallelepipeds that are the smallest rectangular parallelepipeds containing the respective predicted regions V1 and V2 are extracted, and the entire cross-sectional image set 320 including the cross-sectional image 320_X0 not having target sites designated thereon is translated in the x- and y-directions, so that the barycentric positions of the inscribed rectangular parallelepipeds of the predicted regions V1 and V2 are adjusted to each other (step S31 of FIG. 13).

Such an affine transform as to adjust the apexes of the inscribed rectangular parallelepipeds of the predicted regions V1 and V2 to each other is then calculated, and the affine transform to adjust the apex of the inscribed rectangular parallelepiped of the predicted region V2 to the apex of the inscribed parallelepiped of the predicted region V1 is carried out (step S32 of FIG. 13).

Further, the cross-sectional images each having the largest relative lesion-site area with respect to the predicted regions V1 and V2 are detected, and the entire cross-sectional image set 320 including the cross-sectional image 320_X0 not having target sites designated thereon is translated in the slice direction (the z-direction), so that the barycentric points of the lesion sites on the detected cross-sectional images are adjusted to each other (step S33 of FIG. 13).

By carrying out the procedures of steps S31, S32, and S33, the amount of the displacements of the cross-sectional image set 320 with respect to the cross-sectional image set 310 are obtained.

A rigid transform to maximize the overlap between the predicted regions V1 and V2 (in this embodiment, a linear transform through a combination of parallel shift and rotation) is then calculated through a series of procedures.

As the initial matrix of a rigid transform matrix X to carry out a rigid transform, a transform matrix is set to carry out the parallel shift to adjust the barycentric points of the lesion sites in the predicted regions V1 and V2 to each other in the cross-sectional images forming the cross-sectional image sets 310 and 320.

First, the cross-sectional image sets 310 and 320 are aligned with each other in accordance with the transform matrix M, and the coefficient of agreement is calculated to evaluate the degree of the overlap between the predicted regions V1 and V2 (step S34 of FIG. 13). Here, the total sum of the areas of overlaps between the lesion sites in the predicted regions V1 and V2 in the cross-sectional images forming the cross-sectional image sets 310 and 320 is calculated as the coefficient of agreement.

Based on the rigid transform matrix M, a new transform matrix M′ having a predetermined amount of parallel shift and rotation added thereto is generated (step S35 of FIG. 13).

After the transform matrix M′ is generated, the cross-sectional image sets 310 and 320 are aligned with each other in accordance with the transform matrix M′, and the coefficient of agreement is calculated in the same manner as in step S34. If there is an increase in the coefficient of agreement (“Yes” in step S36 of FIG. 13), there is an increase in the overlapped area between the lesion sites in the predicted regions V1 and V2, and the newly generated transform matrix M′ is set as the rigid transform matrix M (step S37 of FIG. 13).

Based on the new rigid transform matrix M, a transform matrix M′ having a predetermined amount of parallel shift and rotation added thereto is newly generated, and the cross-sectional image sets 310 and 320 are aligned with each other in accordance with the new conversion matrix M′. The coefficient of agreement is then calculated. The procedures of steps S35 through S37 are repeated until there is not an increase in the coefficient of agreement.

If there is not an increase in the coefficient of agreement (“No” in step S36 of FIG. 13), the rigid transform matrix M is not changed, and a reference coefficient of agreement is newly calculated (step S38 of FIG. 13). Using the overlapped area S between the lesion sites in the predicted regions V1 and V2 and the correlation coefficient N of the density value in the overlapped area in the cross-sectional images forming the cross-sectional image sets 310 and 320, the coefficient of agreement is calculated by the following equation:

Coefficient of agreement=aS×bN (1)

In the equation (1), the coefficients “a” and “b” are set in accordance with the type of the lesion or the like.

Based on the rigid transform matrix M, a new transform matrix M″ having a density value as well as a predetermined amount of parallel shift and rotation added thereto is generated (step S39 of FIG. 13).

After the transform matrix M″ is generated, the cross-sectional image sets 310 and 320 are aligned with each other in accordance with the transform matrix M″, and the coefficient of agreement is calculated in the same manner as in step S38. If there is an increase in the coefficient of agreement (“Yes” in step S40 of FIG. 13), the newly generated transform matrix M″ is set as the rigid transform matrix M (step S41 of FIG. 13).

The procedures of steps S39 through S41 are repeated until there is not an increase in the coefficient of agreement.

In this manner, the positioning operation is performed.

After the positioning operation is finished (step S24 of FIG. 12), the coordinates of the target site P1′ corresponding to the target site P1 on the cross-sectional image 310_X0 are calculated based on the displacement amount obtained through the positioning operation. Further, cross-sectional images showing the target site P1′ are detected from the cross-sectional images of the cross-sectional image set 320 (step S25 of FIG. 12).

In this embodiment, the two target sites P1_1 and P1_2 are designated on the cross-sectional image 310_X0 shown in FIG. 11, and two cross-sectional images showing the target sites P1′_1 and P1′_2 corresponding to the two target sites P1_1 and P1_2 are detected through the series of procedures shown in FIG. 12. The detected cross-sectional images are transmitted to the image display section 270, and are displayed on the cross-sectional image display screen 411.

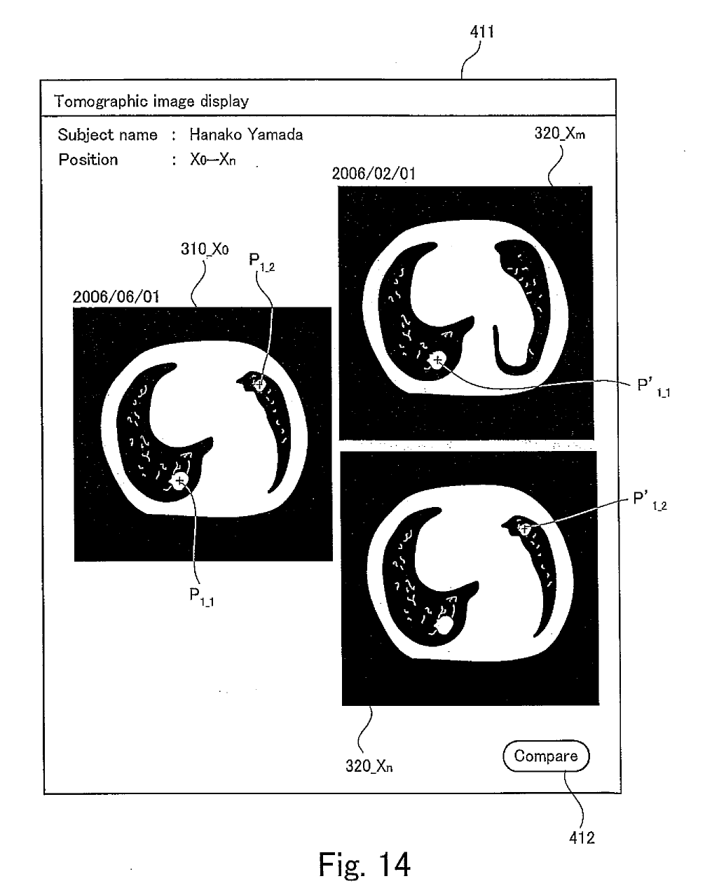

FIG. 14 shows an example of the cross-sectional image display screen 411 on which the detected cross-sectional images 320_Xn and 320_Xm are displayed.

On the cross-sectional image display screen 411 shown in FIG. 14, the cross-sectional images 320_Xn and 320_Xm including the target sites P1′_1 and P1′_2 corresponding to the target sites P1_1 and P1_2 on the cross-sectional image 310_X0 are displayed next to the cross-sectional image 310_X0. The respective target sites P1′_1 and P1′_2 are marked with symbols.

As described above, in the case where more than one target site is set on one cross-sectional image, cross-sectional images are searched for the respective target sites. In this manner, changes in more than one lesion or the like can be recognized at once.

Although cross-sectional images detected from two sets of cross-sectional images are displayed in the above embodiments, the image display section of the present invention may display cross-sectional images detected from three or more sets of cross-sectional images.

Also, in the above embodiments, cross-sectional images showing the sites corresponding to the target sites are detected from cross-sectional images having the displacements corrected. However, the cross-sectional image search section of the present invention may search cross-sectional images having the displacements not corrected.

Also, in the above embodiments, a target point is set on a cross-sectional image. However, the target site setting section of the present invention, for example, may designate a target area in a cross-sectional image. If a target area is designated, the designated area may be used as the target area in an image matching process.

Also, in the above embodiments, a user manually designates a target site that is suspected to be a lesion on the cross-sectional image. However, the target site setting section of the present invention may perform image processing so as to search cross-sectional images for an image portion having an image pattern similar to the sample image. The detected image portion is then set as the target site. In a case where an arterial phase and a delayed phase are compared and interpreted through image-reading, for example, the lesion site is first automatically extracted from the arterial phase in which it is easy to detect a lesion because the movement of the contrast agent is fast and the image density is high. After that, a cross-sectional image including the site corresponding to the automatically extracted lesion site can be detected from the delayed phase in accordance with the present invention.

The image display device of the present invention may also store the locations of lesion sites seen in the cross-sectional images captured in the past. When a new set of cross-sectional images is provided, the image display device displays a list of the lesion sites of the past, and prompts a user to select the location of a lesion site. The selected location is then set as the target site in the current operation.

In a case where a target site is designated in the right lung field or left lung field, for example, the image display device of the present invention may set the center point of the right lung field and left lung field as the target site.

Also, in the above embodiments, the image display device of the present invention is mounted on a diagnosis device. However, the image display device of the present invention may be mounted on a management server or the like.

What is claimed is:

1. An image display device comprising:
an image acquiring section that acquires a plurality of sets of cross-sectional images of a subject captured at a plurality of image capturing positions arranged in a predetermined direction with respect to the subject;
a target site setting section that sets a target site on a cross-sectional image of one of the cross-sectional image sets acquired by the image acquiring section;
a cross-sectional image search section that detects a cross-sectional image including a site corresponding to the target site from a plurality of cross-sectional images forming another one of the cross-sectional image sets excluding the cross-sectional image set having the target site set therein by the target site setting section; and
an image display section that displays the cross-sectional image detected by the cross-sectional image search section.

2. The image display device according to claim 1, wherein the image display section displays the cross-sectional image having the target site set thereon by the target site setting section and the cross-sectional image detected through the search performed by the cross-sectional search section side by side.

3. The image display device according to claim 1, wherein:
the target site setting section is capable of setting a plurality of target sites on a cross-sectional image; and
the cross-sectional image search section searches each cross-sectional image for sites corresponding to the target sites set by the target site setting section.

4. The image display device according to claim 1, further comprising a displacement correcting section that corrects displacements between cross-sectional images of the cross-sectional image sets,
wherein the cross-sectional image search section detects a cross-sectional image including the target site from the cross-sectional images having the displacements corrected by the displacement correcting section.

5. The image display device according to claim 1, wherein the plurality of cross-sectional image sets are obtained by photographing the same subject at different times.

6. The image display device according to claim 1, wherein the cross-sectional image search section searches for a cross-sectional image including a site corresponding to the target site, with the assistance of image features that are obtained beforehand by a machine learning technique.

7. An image display program storage medium that stores an image display program that is executed in a computer to implement in the computer:
an image acquiring section that acquires a plurality of sets of cross-sectional images of a subject captured at a plurality of image capturing positions arranged in a predetermined direction with respect to the subject;
a target site setting section that sets a target site on a cross-sectional image of one of the cross-sectional image sets acquired by the image acquiring section;
a cross-sectional image search section that detects a cross-sectional image including a site corresponding to the target site from a plurality of cross-sectional images forming another one of the cross-sectional image sets excluding the cross-sectional image set having the target site set therein by the target site setting section; and
an image display section that displays the cross-sectional image detected by the cross-sectional image search section.
